(19) United States
(12) Patent Application Publication
(10) Pub. No.: US 2022/0048173 A1
(43) Pub. Date: Feb. 17, 2022

(54) SEPARATING DEVICE, MAGAZINE ATTACHMENT AND FASTENING SYSTEM

(71) Applicant: Hilti Aktiengesellschaft, Schaan (LI)

(72) Inventors: Thomas FOSER, Balzers (LI); Michael RUHSTALLER, Galgenen (CH)

(21) Appl. No.: 17/416,277

(22) PCT Filed: Dec. 4, 2019
(86) PCT No.: PCT/EP2019/083635

§ 371 Date: Jun. 18, 2021

(30) Foreign Application Priority Data
Dec. 21, 2018 (EP) 18215032.6

(51) Int. Cl. B25C 1/00; B23P 19/00; B25B 23/04

(52) U.S. Cl. CPC B25C 1/001; B25B 23/04; B23P 19/006

(57) ABSTRACT

A separating device separating fastening elements from a container comprises a transfer channel for transferring fastening elements in a transfer direction, the transfer channel having a separating section; a stop element, having a blocking position, in which the stop element projects into the separating section, blocking the channel for the fastening element, such that one fastening element rests against the stop element in a waiting position, and an onward transfer position, in which the stop element allows movement of the fastening element in the transfer direction to a standby position; and a retention element, having a retaining position, in which the retention element projects into the separating section, blocking the channel for the fastening element, such that the fastening element rests against the retention element in the standby position, and a release position, in which the retention element allows fastening element movement in the transfer direction beyond the separating section.

The invention relates to a separating device, to a magazine attachment having a separating device of this kind, and to a fastening system having a driving device and a magazine attachment of this kind.

Fastening elements, e.g. screws or nails, are usually separated from the fastening element strip during the process of being driven into an underlying surface by a driving device. Separating devices in which fastening elements fill a container, from which they are separated and transferred in a transfer direction, are known.

It is an object of the invention to make available a separating device, a magazine attachment and a fastening system by means of which a separating process is improved in each case.

The object is achieved in the case of a separating device for separating a fastening element from a container filled with fastening elements, having a transfer channel for transferring the fastening elements in a transfer direction, wherein the transfer channel has a separating section, having a stop element, which has a blocking position, in which the stop element projects into the separating section and blocks the transfer channel for the fastening element, with the result that one fastening element rests against the stop element in a waiting position, and an onward transfer position, in which the stop element allows a movement of the fastening element in the transfer direction to a standby position, and having a retention element, which has a retaining position, in which the retention element projects into the separating section and blocks the transfer channel for the fastening element, with the result that the fastening element rests against the retention element in the standby position, and a release position, in which the retention element allows a movement of the fastening element in the transfer direction beyond the separating section. It is thereby possible to convey the fastening elements individually into the standby position and then to transfer them onward.

One advantageous embodiment is characterized in that the stop element and the retention element are at an adjustable distance from one another in the transfer direction. This enables the separating device to be used for fastening elements of different sizes and/or shapes.

One advantageous embodiment is characterized in that the stop element can be moved linearly between the blocking position and the onward transfer position. An alternative embodiment is characterized in that the stop element can be pivoted between the blocking position and the onward transfer position. Another advantageous embodiment is characterized in that the retention element can be moved linearly between the retaining position and the release position. An alternative embodiment is characterized in that the retention element can be pivoted between the retaining position and the release position.

One advantageous embodiment is characterized in that each fastening element defines a fastening direction in which the fastening element is provided for driving into an underlying surface, and wherein the transfer channel has a profile which determines an orientation of the fastening elements in which the fastening direction is oriented transversely to the transfer direction.

One advantageous embodiment is characterized in that the separating device is inserted into a magazine attachment for a driving device for driving fastening elements into an underlying surface, wherein the magazine attachment comprises an add-on part, which has a connecting region for connecting the magazine attachment to the driving device, and a contact pressure part, which has a contact region for placing the magazine attachment against the underlying surface, wherein the add-on part and the contact pressure part are held against one another so as to be movable along a path of movement in a contact pressure direction, wherein the path of movement is bounded by a normal position and a contact pressure position, and wherein the magazine attachment comprises a separating device as claimed in any one of the preceding claims.

One advantageous embodiment is characterized in that the contact pressure part has the separating device, wherein the add-on part has an actuating element, which actuates the stop element and/or the retention element when the add-on part and the contact pressure part are moved relative to one another in the contact pressure direction. Another advantageous embodiment is characterized in that the add-on part has the separating device, wherein the contact pressure part has an actuating element, which actuates the stop element and/or the retention element when the add-on part and the contact pressure part are moved relative to one another in the contact pressure direction.

One advantageous embodiment is characterized in that the stop element is in the blocking position in the normal position of the magazine attachment and is in the onward transfer position in the contact pressure position of the magazine attachment, and wherein the retention element is in the release position in the normal position of the magazine attachment and is in the retaining position in the contact pressure position of the magazine attachment. An alternative embodiment is characterized in that the stop element is in the onward transfer position in the normal position of the magazine attachment and is in the blocking position in the contact pressure position of the magazine attachment, and wherein the retention element is in the retaining position in the normal position of the magazine attachment and is in the release position in the contact pressure position of the magazine attachment.

One advantageous embodiment is characterized in that the contact pressure part has a receptacle for a fastening element and a passage for a driving element, which is mounted on the driving device and with the aid of which a fastening element in the receptacle can be driven into the underlying surface, wherein the transfer channel is provided for the purpose of feeding a fastening element separated in the separating section to the receptacle.

One advantageous embodiment is characterized in that the magazine attachment is inserted into a fastening system, which comprises a driving device for driving fastening elements into an underlying surface, wherein the connecting region is connected to the driving device. The driving device is preferably designed as a power drill or driver, particularly preferably as a rechargeable battery-operated driver.

The fastening system is preferably provided for use in a spatial orientation in which the stop element is arranged above the retention element, with the result that the transfer of the transfer elements in the separating section is assisted or brought about by means of gravity.

The fastening element preferably comprises a tip and/or a head. The fastening element is preferably provided with a thread and designed as a screw. In alternative embodiments, the fastening element is designed as a nail, bolt or similar.

Preferred exemplary embodiments are explained in greater detail below with reference to the drawings. In the drawings:

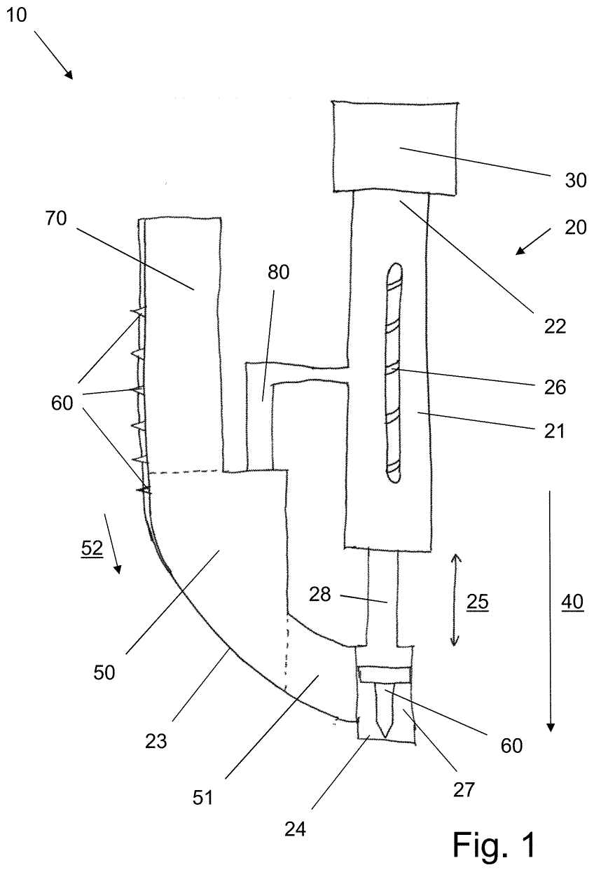

FIG. 1 shows a fastening system, and

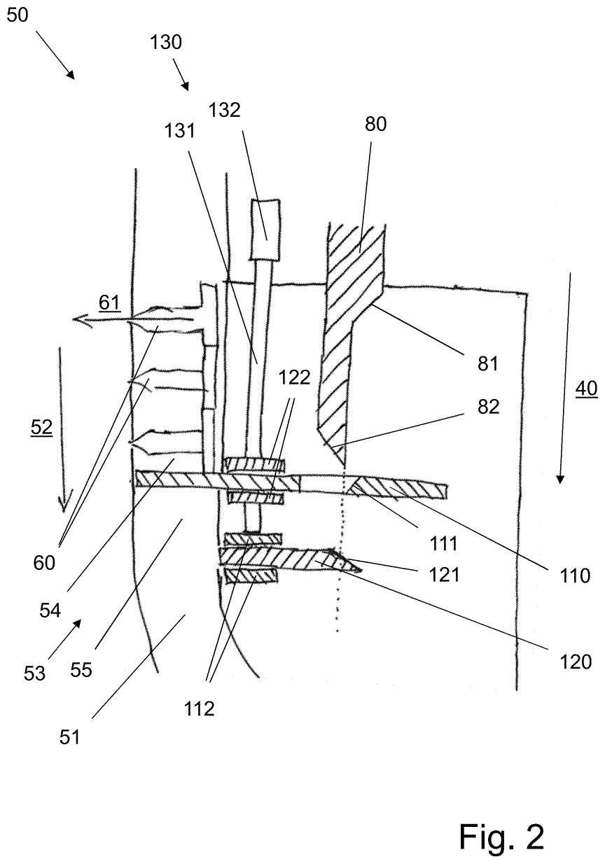

FIG. 2 shows a separating device in a cross section.

FIG. 1 shows a fastening system 10 having a driving device 30, designed as a rechargeable battery-operated driver for example, and a magazine attachment 20 provided for said device. The magazine attachment 20 comprises an add-on part 21, which has a connecting region 22 for connecting the magazine attachment 20 to the driving device 30, and a contact pressure part 23, which has a contact region 24 for placing the magazine attachment 20 against an underlying surface (not illustrated). The add-on part 21 and the contact pressure part 23 are held against one another so as to be movable along a path of movement 25 in a contact pressure direction 40, wherein the path of movement 25 is bounded by a normal position and a contact pressure position. A contact pressure spring 26 preloads the add-on part 21 and the contact pressure part 23 into the normal position, with the result that the magazine attachment 20 and thus the fastening system 10 is pressed against an underlying surface counter to a spring force of the contact pressure spring 26.

The contact pressure part 23 has a receptacle 27 for a fastening element 60, and a passage 28 for a driving element, which is mounted on the driving device 30 and with the aid of which the fastening element 60 in the receptacle 27 can be driven into the underlying surface. The fastening element 60 is designed as a screw having a thread and a head. The driving element (not illustrated) is designed as a screw bit. In exemplary embodiments that are not shown, the fastening elements are designed as nails, bolts or the like.

The contact pressure part 23 comprises a separating device 50 for separating a fastening element 60 from a container 70 filled with fastening elements 60. The add-on part 21 has an actuating element 80 for actuating the separating device 50 when the add-on part 21 and the contact pressure part 23 are moved relative to one another in the contact pressure direction 40, e.g. when the fastening system 10 is pressed against an underlying surface. In exemplary embodiments that are not shown, the add-on part has the separating device, and the contact pressure part has an actuating element for actuating the separating device when the add-on part and the contact pressure part are moved relative to one another in the contact pressure direction. The separating device 50 comprises a transfer channel 51 for transfer of the fastening elements 60 in a transfer direction 52 in order in each case to feed a separated fastening element 60 to the receptacle 27.

FIG. 2 shows the separating device 50 with the transfer channel 51 in a cross-sectional view. The transfer channel 51 has a separating section 53. The separating device 50 comprises a stop element 110 and a retention element 120. The stop element 110 is illustrated in a blocking position, in which it projects into the separating section 53 and blocks the transfer channel 51 for the fastening elements 60, with the result that one fastening element 60 rests against the stop element 110 in a waiting position 54. The retention element 120 is illustrated in a release position, in which it allows a movement of the fastening element 60 in the transfer direction 52 beyond the separating section 53. The blocking position of the stop element 110 and the release position of the retention element 120 correspond to the normal position of the magazine attachment.

Each fastening element 60 defines a fastening direction 61 in which the fastening element 60 is provided for driving into an underlying surface. The transfer channel 51 has a profile which determines an orientation of the fastening elements transversely to the transfer direction 52. The fastening direction 61 is preferably oriented perpendicularly to the transfer direction 52.

If, starting from the normal position, the magazine attachment is transferred to the contact pressure position by contact pressure on the fastening system, the actuating element 80 moves with the add-on part in the driving direction 40 relative to the contact pressure part and hence to the separating device 50. The actuating element 80 has a first actuating surface 81 for actuating the stop element 110, and a second actuating surface 82 for actuating the retention element 120. For this purpose, the stop element 110 and the retention element 120 have a first mating surface 111 and a second mating surface 121, respectively. Owing to the fact that a distance between the first actuating surface 81 and the second actuating surface 82, measured in the driving direction 40, is substantially equal to a distance between the first mating surface 111 and the second mating surface 121, measured in the driving direction 40, the retention element 120 is actuated (to the left in FIG. 2) and, at the same time, the stop element 110 is actuated substantially simultaneously (to the right in FIG. 2) when the magazine attachment is subject to contact pressure against the underlying surface. By means of said actuation, the stop element 110 is transferred to an onward transfer position, in which it allows a movement of the fastening element 60 in the transfer direction 52 to a standby position 55. The retention element 120 is transferred by said actuation into a retaining position, in which it projects into the separating section 53 and blocks the transfer channel 51 for the fastening element 60, with the result that the fastening element 60 rests against the retention element 120 in the standby position 55.

When the magazine attachment is raised from the underlying surface, the actuating element 80 moves back into the position shown in FIG. 2 again and allows a movement of the stop element 110 back into the blocking position and a movement of the retention element 120 back into the release position. As a result, the fastening element 60 arranged in the standby position 55 can move onward into the transfer channel 51. The return movement of the stop element 110 and of the retention element 120 is brought about by springs (not illustrated), which preload the stop element 110 toward the blocking position and the retention element 120 toward the release position.

The stop element 110 is in the blocking position in the normal position of the magazine attachment and is in the onward transfer position in the contact pressure position of the magazine attachment, and the retention element is in the release position in the normal position of the magazine attachment and is in the retaining position in the contact pressure position of the magazine attachment. In exemplary embodiments that are not shown, the stop element is in the onward transfer position in the normal position of the magazine attachment and is in the blocking position in the contact pressure position of the magazine attachment, wherein the retention element is then in the retaining position in the normal position of the magazine attachment and is in the release position in the contact pressure position of the magazine attachment.

The separating device 50 has a first guide element 112 for a guided linear movement of the stop element 110 between the blocking position and the onward transfer position, and a second guide element 122 for a guided linear movement of the retention element 120 between the release position and the retaining position. In exemplary embodiments that are not shown, the stop element can be pivoted between the blocking position and the onward transfer position and/or the retention element can be pivoted between the retaining position and the release position.

A distance between the stop element 110 and the retention element 120, measured in the transfer direction 52, is chosen so that there can be only one fastening element in the standby position 55. Thus, if the fastening system is pressed against an underlying surface, just one fastening element 60 is allowed through into the standby position 55 by the stop element 110. If the fastening system is raised from the underlying surface again after a driving process, the fastening element 60 is allowed through by the retention element 120 into the transfer channel 51, in which it can move unhindered as far as the receptacle of the contact pressure part owing to gravity and is ready there to be driven into the underlying surface in a subsequent driving process. Thus, the fastening elements 60 are conveyed individually into the standby position 55 and then transferred onward to the receptacle.

To adapt the size of the standby position 55 to different sizes and/or shapes of the fastening elements, the separating device 50 has an adjusting device 130, by means of which the distance between the stop element 110 and the retention element 120, measured in the transfer direction 52, can be adjusted. For this purpose, the adjusting device 130 has an adjusting element 131, which is designed as an adjusting screw, is guided on the first guide element 112 by an adjusting thread (not illustrated) and rests against the second guide element 122. The adjusting element 131 has an operating element 132, allowing a user of the magazine attachment to adjust the distance between the first guide element 112 and the second guide element 122 and hence the distance between the stop element 110 and the retention element 120 by rotating the operating element 132.

The invention has been explained above by means of a number of exemplary embodiments of a separating device, of a magazine attachment and of a fastening system. In this respect, the features described can be transferred individually or in combination from each exemplary embodiment to all other exemplary embodiments as long as they do not contradict one another. It should be noted that the device according to the invention can also be used for other purposes.

1. A separating device for separating a fastening element from a container filled with fastening elements, comprising a transfer channel for transferring the fastening elements in a transfer direction, wherein the transfer channel has a separating section, having a stop element, which has a blocking position, in which the stop element projects into the separating section and blocks the transfer channel for the fastening element, with the result that one fastening element rests against the stop element in a waiting position, and an onward transfer position, in which the stop element allows a movement of the fastening element in the transfer direction to a standby position; and a retention element, which has a retaining position, in which the retention element projects into the separating section and blocks the transfer channel for the fastening element, with the result that the fastening element rests against the retention element in the standby position, and a release position, in which the retention element allows a movement of the fastening element in the transfer direction beyond the separating section.

2. The separating device as claimed in claim 1, wherein the stop element and the retention element are at an adjustable distance from one another in the transfer direction.

3. The separating device as claimed in claim 1, wherein the stop element can be moved linearly between the blocking position and the onward transfer position.

4. The separating device as claimed in claim 1, wherein the stop element can be pivoted between the blocking position and the onward transfer position.

5. The separating device as claimed in claim 1, wherein the retention element can be moved linearly between the retaining position and the release position.

6. The separating device as claimed in claim 1, wherein the retention element can be pivoted between the retaining position and the release position.

7. The separating device as claimed in claim 1, wherein each fastening element defines a fastening direction in which the fastening element is provided for driving into an underlying surface, and wherein the transfer channel has a profile which determines an orientation of the fastening elements in which the fastening direction is oriented transversely to the transfer direction.

8. A magazine attachment for a driving device for driving fastening elements into an underlying surface, having an add-on part, which has a connecting region for connecting the magazine attachment to the driving device, and having a contact pressure part, which has a contact region for placing the magazine attachment against the underlying surface, wherein the add-on part and the contact pressure part are held against one another so as to be movable along a path of movement in a contact pressure direction, wherein the path of movement is bounded by a normal position and a contact pressure position, and wherein the magazine attachment comprises a separating device as claimed in claim 1.

9. The magazine attachment as claimed in claim 8, wherein the contact pressure part has the separating device, wherein the add-on part has an actuating element, which actuates the stop element and/or the retention element when the add-on part and the contact pressure part are moved relative to one another in the contact pressure direction.

10. The magazine attachment as claimed in claim 8, wherein the add-on part has the separating device, wherein the contact pressure part has an actuating element, which actuates the stop element and/or the retention element when the add-on part and the contact pressure part are moved relative to one another in the contact pressure direction.

11. The magazine attachment as claimed in claim 8, wherein the stop element is in the blocking position in the normal position of the magazine attachment and is in the onward transfer position in the contact pressure position of the magazine attachment, and wherein the retention element is in the release position in the normal position of the magazine attachment and is in the retaining position in the contact pressure position of the magazine attachment.

12. The magazine attachment as claimed in claim 8, wherein the stop element is in the onward transfer position in the normal position of the magazine attachment and is in the blocking position in the contact pressure position of the magazine attachment, and wherein the retention element is in the retaining position in the normal position of the magazine attachment and is in the release position in the contact pressure position of the magazine attachment.

13. The magazine attachment as claimed in claim 8, wherein the contact pressure part has a receptacle for a fastening element, a passage for a driving element, which is mounted on the driving device and with the aid of which a fastening element in the receptacle can be driven into the underlying surface, and wherein the transfer channel is provided for the purpose of feeding a fastening element separated in the separating section to the receptacle.

14. A fastening system comprising a driving device for driving fastening elements into an underlying surface and a magazine attachment as claimed in claim 8, wherein the connecting region is connected to the driving device.

15. The fastening system as claimed in claim 14, for use in a spatial orientation in which the stop element is arranged above the retention element, with the result that the transfer of the transfer elements in the separating section is assisted or brought about by gravity.
Add the following claims:

16. The fastening system as claimed in claim 14, wherein the driving device is a power drill or driver.

17. The separating device as claimed in claim 2, wherein the stop element can be moved linearly between the blocking position and the onward transfer position.

18. The separating device as claimed in claim 2, wherein the stop element can be pivoted between the blocking position and the onward transfer position.

19. The separating device as claimed in claim 3, wherein the stop element can be pivoted between the blocking position and the onward transfer position.

20. The separating device as claimed in claim 2, wherein the retention element can be moved linearly between the retaining position and the release position.
